(19) United States
(12) Patent Application Publication
(10) Pub. No.: US 2020/0062393 A1
(43) Pub. Date: Feb. 27, 2020

(54) UNMANNED AERIAL VEHICLE KIT AND SYSTEM

(71) Applicant: Samsung Electronics Co., Ltd., Gyeonggi-do (KR)

(72) Inventors: Yeonggyu YOON, Gyeonggi-do (KR); Minsung LEE, Gyeonggi-do (KR); Minwoo YOO, Gyeonggi-do (KR); Jongchul CHOI, Gyeonggi-do (KR)

(21) Appl. No.: 16/462,664

(22) PCT Filed: Dec. 8, 2017
(86) PCT No.: PCT/KR2017/014415

§ 371 Date: May 21, 2019

(30) Foreign Application Priority Data
Jan. 3, 2017 (KR) 10-2017-0000806

(51) Int. Cl. B64C 39/02; G05D 1/10

(52) U.S. Cl. CPC B64C 39/024; G05D 1/101; B64C 2201/12; B64C 2201/108; B64C 2201/024

(57) ABSTRACT

An unmanned aerial vehicle kit and a system according to various embodiments of the present invention comprise a first assembly and a second assembly. The first assembly comprises: a housing comprising a processor and a navigation system; at least one first propeller which is connected to or mounted on the housing, and which has a direction set such that the same rotates about a first axis extending in a first direction; at least one first motor which drives the at least one first propeller, and which is configured to be controlled by at least one of the processor and the navigation system; and at least one first electric contact electrically connected to the processor. The second assembly comprises: a frame that can be connected to the first assembly in an attachable/detachable manner; at least one second electric contact that can be electrically connected to the at least one first electric contact when the frame is connected to the first assembly; at least one second propeller which is connected to or mounted on the frame, and which has a direction set such that the same rotates about a second axis that is different from the first axis; and at least one second motor which drives the at least one second propeller, and which is configured to be controlled by at least one of the processor and the navigation system. At least one of the processor and the navigation system is configured to selectively drive the first motor or the second motor according to whether the second assembly has been connected to the first assembly or not, and the first assembly can accordingly transfer a control signal corresponding to the type of the second assembly to the second assembly. Various embodiments other than the embodiments disclosed in the present specification are also possible.

### TECHNICAL FIELD

Various embodiments of the disclosure relates to an unmanned aerial vehicle kit and system that can be extended in various ways.

### BACKGROUND ART

An unmanned aerial vehicle is a flight vehicle that is designed to perform a specified mission without a pilot onboard.

An unmanned aerial vehicle may be called various names such as a drone and an unmanned aircraft system. Unmanned aerial vehicles may in a broad sense include unmanned ground vehicles.

To remotely control the position and attitude of the unmanned aerial vehicle, an onboard computer may be used to wirelessly communicate with a remote control device.

### DISCLOSURE OF INVENTION

### Technical Problem

Unmanned aerial vehicles can be manufactured in various forms such as indoor, outdoor, ground, air and underwater depending on the usage environments.

Unmanned aerial vehicles can be used in various applications or fields such as photography, reconnaissance, broadcasting, industry, leisure, life-saving, and courier depending on the purpose of use.

However, it may be difficult for one unmanned aerial vehicle of a user to satisfy both the environmental conditions and the purposes described above.

It may also be difficult for the user to have all the unmanned aerial vehicles suitable for the various environments and purposes described above.

Accordingly, various embodiments of the disclosure are to provide an unmanned aerial vehicle kit and system that include a first assembly (e.g., core drone) including a processor and a navigation system, and a second assembly (e.g., frame drone) electrically connected to the first assembly and operating under the control of the first assembly wherein the first assembly delivers a control signal corresponding to the type of the second assembly (e.g., flying vehicle or traveling vehicle) to the second assembly.

### Solution to Problem

According to an embodiment of the disclosure, there is provided an unmanned aerial vehicle kit. The unmanned aerial vehicle kit may include: a first assembly including: a housing including a processor and a navigation system; at least one first propeller connected to or mounted on the housing and oriented to rotate about a first axis extending in a first direction; at least one first motor configured to drive the at least one first propeller and be controlled by at least one of the processor or the navigation system; and at least one first electrical contact electrically connected to the processor; and a second assembly including: a frame detachably connectable to the first assembly; at least one second electrical contact electrically connectable to the at least one first electrical contact when the frame is connected to the first assembly; at least one second propeller connected to or mounted on the frame and oriented to rotate about a second axis different from the first axis; and at least one second motor configured to drive the at least one second propeller and be controlled by at least one of the processor or the navigation system, wherein at least one of the processor or the navigation system may be configured to selectively drive the first motor or the second motor depending on whether the second assembly is connected to the first assembly.

According to an embodiment of the disclosure, there is provided an unmanned aerial system. The unmanned aerial system may include: a first assembly including: a housing including a processor and a navigation system; at least one first rotating element connected to or mounted on the housing and oriented to rotate about a first axis extending in a first direction; at least one first motor configured to drive the at least one rotating element and be controlled by at least one of the processor or the navigation system; and at least one first electrical contact electrically connected to the processor; and a second assembly including: a frame detachably connectable to the first assembly; at least one second electrical contact electrically connectable to the at least one first electrical contact when the frame is connected to the first assembly; at least one second rotating element connected to or mounted on the frame and oriented to rotate about a second axis different from the first axis; and at least one second motor configured to drive the at least one second rotating element and be controlled by at least one of the processor or the navigation system, wherein at least one of the processor or the navigation system may be configured to selectively drive the first motor or the second motor depending on whether the second assembly is connected to the first assembly.

According to an embodiment of the disclosure, there is provided an unmanned aerial system. The unmanned aerial system may include: a first assembly including: a housing including a processor and a navigation system; at least one first rotating element connected to or mounted on the housing and oriented to rotate about a first axis extending in a first direction; at least one first motor configured to drive the at least one rotating element and be controlled by at least one of the processor or the navigation system; and at least one first electrical contact electrically connected to the processor; and a second assembly including: a frame detachably connectable to the first assembly; at least one second electrical contact electrically connectable to the at least one first electrical contact when the frame is connected to the first assembly; and at least one second rotating element connected to or mounted on the frame, oriented to rotate about a second axis different from the first axis, and configured to be driven by the at least one first motor when the frame is connected to the first assembly, wherein at least one of the processor or the navigation system may be configured to detect whether the second assembly is connected to the first assembly and automatically change the rotational direction of the least one first motor if the second assembly is connected to the first assembly.

### Advantageous Effects of Invention

According to an embodiment of the disclosure, there is provided an unmanned aerial vehicle kit that include a first assembly including a processor and a navigation system, and a second assembly electrically connected to the first assembly and operating under the control of the first assembly. In particular, the first assembly may deliver a control signal corresponding to the type of the second assembly to the second assembly. Thereby, it is possible for the single unmanned aerial vehicle kit to satisfy various usage conditions and purposes.

### BRIEF DESCRIPTION OF DRAWINGS

FIG. 1A shows an unmanned aerial vehicle kit whose first assembly and second assembly are not yet connected according to various embodiments of the disclosure.

FIG. 1B shows an unmanned aerial vehicle kit whose first assembly and second assembly are connected according to various embodiments of the disclosure.

FIG. 2A illustrates the first assembly of the unmanned aerial vehicle kit according to various embodiments of the disclosure.

FIG. 2B illustrates the back side of the first assembly of the unmanned aerial vehicle kit according to various embodiments of the disclosure.

FIGS. 3A and 3B illustrate the second assembly of the unmanned aerial vehicle kit according to various embodiments of the disclosure.

Part (A) of FIG. 4 is a view showing the connection state between the first assembly and the second assembly of the unmanned aerial vehicle kit according to various embodiments of the disclosure.

Part (B) of FIG. 4 is an enlarged view of the section taken along the line A-A′ in part (A) of FIG. 4.

FIG. 5 is a cross-sectional view illustrating a portion of the connection state between the first assembly and the second assembly of the unmanned aerial vehicle kit according to various embodiments of the disclosure.

FIG. 6 illustrates a connection sequence of the unmanned aerial vehicle kit according to various embodiments of the disclosure.

FIG. 7 shows another unmanned aerial vehicle kit according to various embodiments of the disclosure.

FIG. 8 illustrates different unmanned aerial vehicle kits according to various embodiments of the disclosure.

FIG. 9 illustrates another example of the unmanned aerial vehicle kit according to various embodiments of the disclosure.

FIG. 10 is a block diagram of the unmanned aerial vehicle kit according to various embodiments of the disclosure.

FIG. 11A is a flowchart of a method for selectively driving a first motor of the first assembly or a second motor of the second assembly according to various embodiments of the disclosure.

FIG. 11B is a flowchart of a method for changing the control mode of the unmanned aerial vehicle kit according to various embodiments of the disclosure.

FIG. 12 is a block diagram illustrating additional components of the first assembly according to various embodiments of the disclosure.

FIG. 13 shows program modules stored in a memory of the first assembly according to various embodiments of the disclosure.

### MODE FOR THE INVENTION

Hereinafter, the present disclosure will be described with reference to the accompanying drawings. Various embodiments of the present disclosure are not limited to a specific implementation form and it should be understood that the present disclosure includes all changes and/or equivalents and substitutes included in the spirit and scope of various embodiments of the present disclosure.

In connection with descriptions of the drawings, similar components are designated by the same reference numeral.

The terms “have,” “may have,” “include,” and “may include” as used herein indicate the presence of corresponding features (for example, elements such as numerical values, functions, operations, or parts), and do not preclude the presence of additional features.

The terms “A or B,”“at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may indicate different user devices regardless of the order or importance. For example, a first element may be referred to as a second element without departing from the scope the present disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “ adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor) capable of performing a corresponding operation by executing one or more software programs stored in a memory device.

The terms used in describing various embodiments of the present disclosure are for the purpose of describing particular embodiments and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the present disclosure.

Electronic devices according to embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to an embodiment of the present disclosure, the wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

The electronic devices may be smart home appliances. The smart home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ and PlayStation™, electronic dictionaries, electronic keys, camcorders, or electronic picture frames.

The electronic devices may include at least one of various medical devices (e.g., various portable medical measurement devices (such as blood glucose meters, heart rate monitors, blood pressure monitors, or thermometers, and the like), a magnetic resonance angiography (MRA) device, a magnetic resonance imaging (MRI) device, a computed tomography (CT) device, scanners, or ultrasonic devices, and the like), navigation devices, global positioning system (GPS) receivers, event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller machines (ATMs), points of sales (POSs) devices, or Internet of Things (IoT) devices (e.g., light bulbs, various sensors, electric or gas meters, sprinkler devices, fire alarms, thermostats, street lamps, toasters, exercise equipment, hot water tanks, heaters, boilers, and the like).

The electronic devices may further include at least one of parts of furniture or buildings/structures, electronic boards, electronic signature receiving devices, projectors, or various measuring instruments (such as water meters, electricity meters, gas meters, or wave meters, and the like). The electronic devices may be one or more combinations of the above-mentioned devices. The electronic devices may be flexible electronic devices. Also, the electronic devices are not limited to the above-mentioned devices, and may include new electronic devices according to the development of new technologies.

Hereinafter, electronic devices according to various embodiments of the present disclosure will be described with reference to the accompanying drawings. The term “user” as used herein may refer to a person who uses an electronic device or may refer to a device (e.g., an artificial intelligence electronic device) which uses an electronic device.

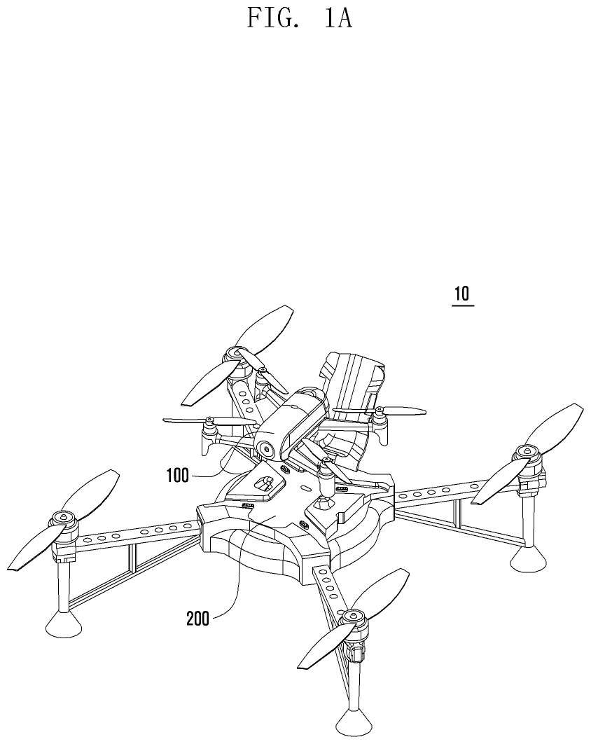

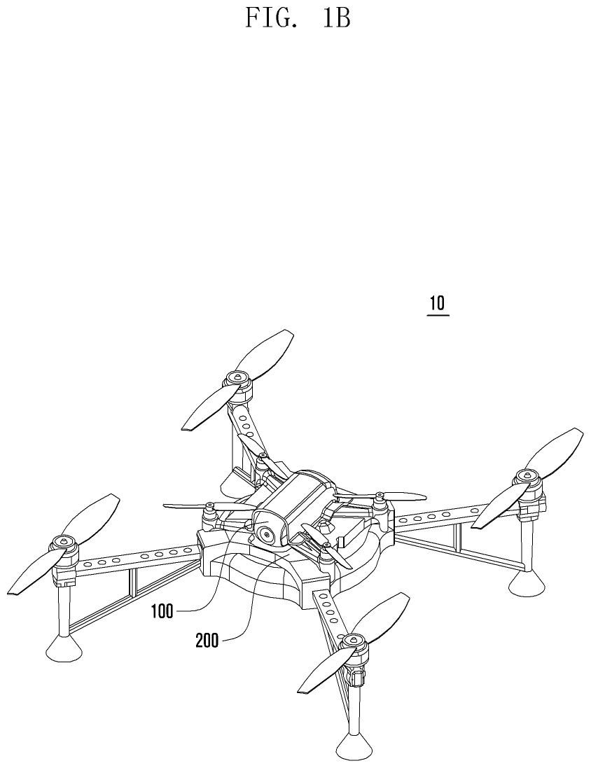

FIGS. 1A and 1B show an unmanned aerial vehicle kit 10 according to various embodiments of the disclosure. FIG. 1A shows the unmanned aerial vehicle kit 10 whose first assembly 100 (core drone) and second assembly 200 (frame drone) are not yet connected. FIG. 1B shows the unmanned aerial vehicle kit 10 whose first assembly 100 and second assembly 200 are connected.

With reference to FIGS. 1A and 1B, the unmanned aerial vehicle kit 10 according to various embodiments of the disclosure may include a core drone 100 and a frame drone 200.

In various embodiments, the core drone 100 may include various electronic components such as a processor controlling the unmanned aerial vehicle kit 10. The core drone 100 may be configured to fly and run the unmanned aerial vehicle kit 10. The core drone 100 can fly or travel alone by remote control. The core drone 100 may be an aerial vehicle capable of flying in the air, a traveling vehicle capable of running on land, or an underwater vehicle capable of travelling in water. Hereinafter, the core drone 100 is referred to as the first assembly 100.

In various embodiments, the frame drone 200 may be detachably connected to the first assembly 100. The frame drone 200 may be electrically connected to the first assembly 100 to constitute the unmanned aerial vehicle kit 10. The frame drone 200 may be under the control of the first assembly 100. The frame drone 200 can be manufactured in various forms according to the usage environment and purpose of the unmanned aerial vehicle kit 10. The frame drone 200 may be an aerial vehicle capable of flying in the air, a traveling vehicle capable of running on land, or an underwater vehicle capable of travelling in water. Hereinafter, the frame drone 100 is referred to as the second assembly 200.

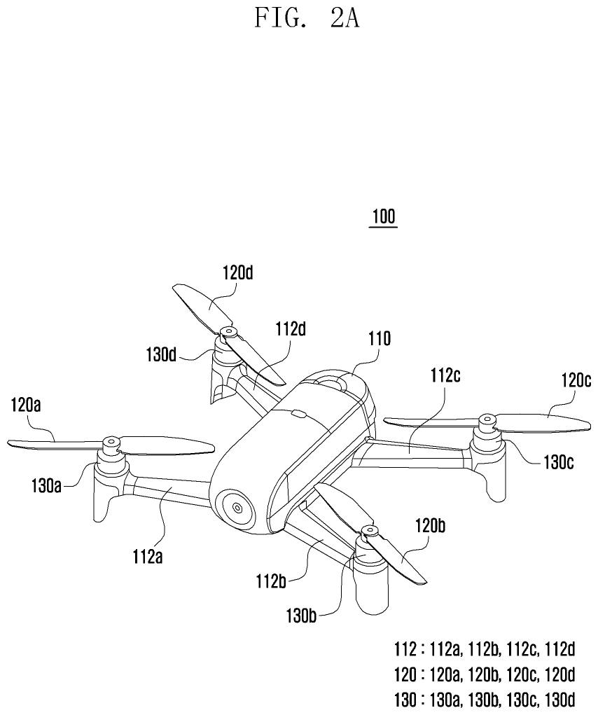

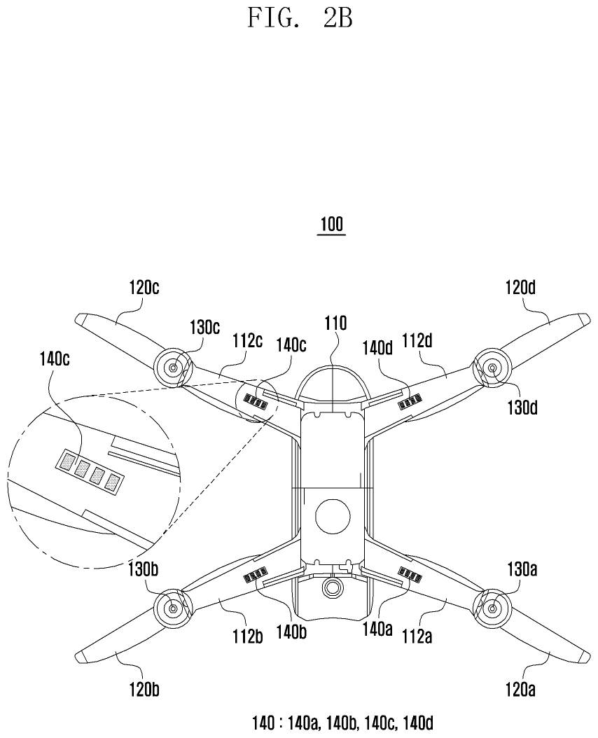

FIG. 2A illustrates the first assembly (e.g., core drone 100) of the unmanned aerial vehicle kit according to various embodiments of the disclosure. FIG. 2B illustrates the back side of the first assembly of the unmanned aerial vehicle kit according to various embodiments of the disclosure.

With reference to FIGS. 2A and 2B, the first assembly 100 of the unmanned aerial vehicle kit according to various embodiments of the disclosure may include a housing 110, first rods 112, first propellers 120, first motors 130, and first electrical contacts 140.

In various embodiments, the housing 110 may be the body of the first assembly 100. The housing 110 may include control means such as a processor and a navigation system. The processor and the navigation system can perform the control function necessary for driving and flying the first assembly 100.

In various embodiments, the housing 110 may include the first rods 112. The first rods 112 may include at least one of rod 1-1 (112a), rod 1-2 (112b), rod 1-3 (112c), or rod 1-4 (112d) each connected to and extending from the housing 110. Among the first rods 112, rod 1-1 (112a) and rod 1-4 (112d) are disposed on one side of the housing 110 and rod 1-2 (112b) and rod 1-3 (112c) are disposed on the other side of the housing 110. Rod 1-1 (112a), rod 1-2 (112b), rod 1-3 (112c), and rod 1-4 (112d) may be arranged approximatively in an X-shaped configuration. With respect to the housing 110, rod 1-1 (112a) and rod 1-2 (112b) may be arranged to face each other, and rod 1-3 (112c) and rod 1-4 (112d) may be arranged to face each other.

[54] In various embodiments, the first propellers 120 may be arranged to fly the first assembly 100. The first propeller 120 may be disposed at the end of the first rod 112 via the first motor 130. The first propellers 120 may include at least one of propeller 1-1 (120a), propeller 1-2 (120b), propeller 1-3 (120c), or propeller 1-4 (120d). Propeller 1-1 (120a), propeller 1-2 (120b), propeller 1-3 (120c) and propeller 1-4 (120d) may be disposed on rod 1-1 (112a), rod 1-2 (112b), rod 1-3 (112c), and rod 1-4 (112d), respectively.

In various embodiments, the first motors 130 may be configured to rotate the first propellers 120 connected to the motor shafts so as to fly the first assembly 100. The first motors 130 may include at least one of motor 1-1 (130a), motor 1-2 (130b), motor 1-3 (130c), or motor 1-4 (130d). The first motor 130 may be disposed inside the end of the first rod 112 connected to the housing 110. Motor 1-1 (130a), motor 1-2 (130b), motor 1-3 (130c), and motor 1-4 (130d) may be disposed inside the ends of rod 1-1 (112a), rod 1-2 (112b), rod 1-3 (112c), and rod 1-4 (112d), respectively. Propeller 1-1 (120a), propeller 1-2 (120b), propeller 1-3 (120c), and propeller 1-4 (120d) may be connected respectively to the motor shafts of motor 1-1 (130a), motor 1-2 (130b), motor 1-3 (130c), and motor 1-4 (130d).

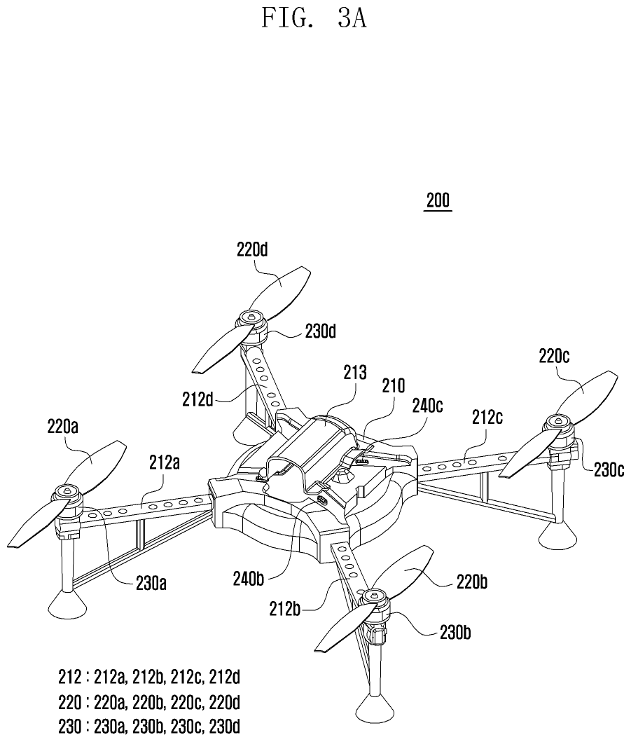

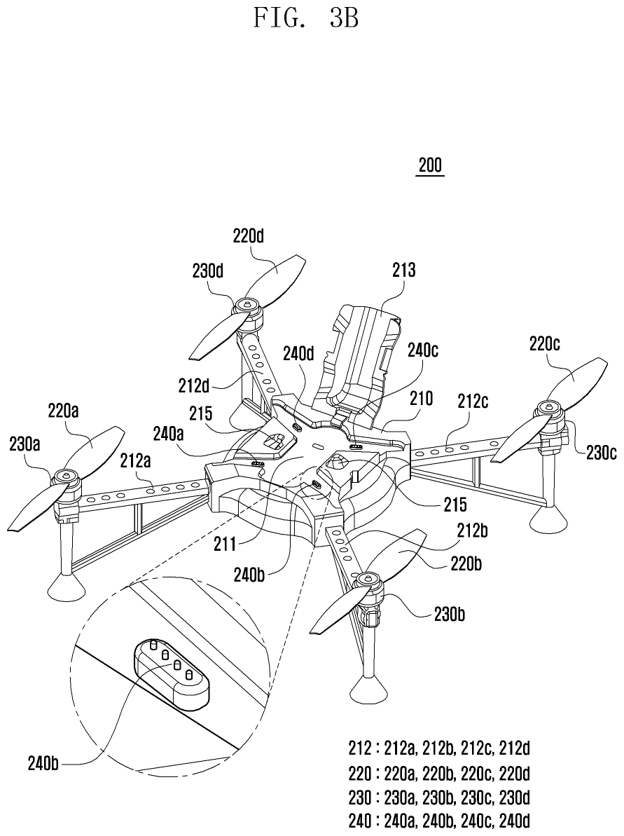

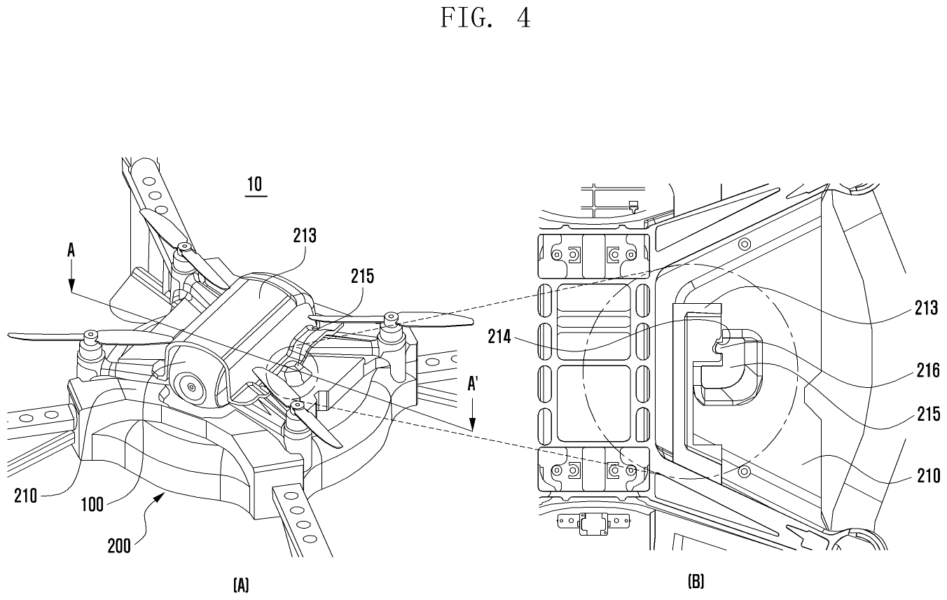

In various embodiments, the first electrical contacts 140 may be electrically connected to the second electrical contacts 240 of the second assembly 200 shown in FIG. 3B. The first electrical contacts 140 may deliver control signals from the control means such as a processor and navigation system of the first assembly 100 to the second assembly 200 through the second electrical contacts.

In various embodiments, the first electrical contacts 140 may be disposed on the back side of the first assembly 100. The first electrical contacts 140 may be a female connector. The first electrical contacts 140 may include at least one of electrical contact 1-1 (140a), electrical contact 1-2 (140b), electrical contact 1-3 (140c), or electrical contact 1-4 (140d). Electrical contact 1-1 (140a), electrical contact 1-2 (140b), electrical contact 1-3 (140c), and electrical contact 1-4 (140d) may be disposed at specific positions of the back sides of rod 1-1 (112a), rod 1-2 (112b), rod 1-3 (112c), and rod 1-4 (112d), respectively.

In various embodiments, the first assembly 100 of the unmanned aerial vehicle kit of the disclosure may include various components in addition to those components described above. The first assembly 100 may have various shapes without being limited to the shape shown in FIG. 2A or 2B. In the first assembly 100, the number of first rods 112, the number of first propellers 120, and the number of first motors 130 may be varied according to the shape of the housing 110. The number of first rods 112 arranged in the first assembly 100 may be 1, 2, . . . , n according to the shape of the housing 110. The number of first propellers 120 arranged in the first assembly 100 may be 1, 2, . . . , n according to the shape of the housing 110. The number of first motors 130 arranged in the first assembly 100 may be 1, 2, . . . , n according to the shape of the housing 110.

FIGS. 3A and 3B illustrate the second assembly (e.g. frame drone 200) of the unmanned aerial vehicle kit according to various embodiments of the disclosure.

With reference to FIGS. 3A and 3B, the second assembly 200 of the unmanned aerial vehicle kit according to various embodiments of the disclosure may include a frame 210, second rods 212, second propellers 220, second motors 230, and second electrical contacts 240.

In various embodiments, the frame 210 may be detachably connected to the first assembly 100. The frame 210 may be integrally connected to the first assembly 100 to constitute the unmanned aerial vehicle kit.

In various embodiments, the frame 210 may include the second rods 212. The second rods 212 may include at least one of rod 2-1 (212a), rod 2-2 (212b), rod 2-3 (212c), or rod 2-4 (212d) each connected to and extending from the frame 210. Among the second rods 212, rod 2-1 (212a) and rod 2-4 (212d) are disposed on one side of the frame 210 and rod 2-2 (212b) and rod 2-3 (212c) are disposed on the other side of the frame 210. Rod 2-1 (212a), rod 2-2 (212b), rod 2-3 (212c), and rod 2-4 (212d) may be arranged approximatively in an X-shaped configuration. With respect to the frame 210, rod 2-1 (212a) and rod 2-2 (212b) may be arranged to face each other, and rod 2-3 (212c) and rod 2-4 (212d) may be arranged to face each other.

In various embodiments, the second propellers 220 may be configured to fly and run the second assembly 200 under the control of the first assembly 100. The second propeller 220 may be disposed at the end of the second rod 212 via the second motor 230. The second propellers 220 may include at least one of propeller 2-1 (220a), propeller 2-2 (220b), propeller 2-3 (220c), or propeller 2-4 (220d). Propeller 2-1 (220a), propeller 2-2 (220b), propeller 2-3 (220c) and propeller 2-4 (220d) may be disposed on rod 2-1 (212a), rod 2-2 (212b), rod 2-3 (212c), and rod 2-4 (212d), respectively. The second propeller 220 may include at least one of a rotating element or a wheel.

In various embodiments, the second motors 230 may be configured to rotate the second propellers 220 connected to the motor shafts so as to fly or run the second assembly 200. The second motors 230 may rotate according to the control signal from the processor of the first assembly 100. The second motors 230 may include at least one of motor 2-1 (230a), motor 2-2 (230b), motor 2-3 (230c), or motor 2-4 (230d). The second motor 230 may be disposed inside the end of the second rod 212 connected to the frame 210. Motor 2-1 (230a), motor 2-2 (230b), motor 2-3 (230c), and motor 2-4 (230d) may be disposed inside the ends of rod 2-1 (212a), rod 2-2 (212b), rod 2-3 (212c), and rod 2-4 (212d), respectively. Propeller 2-1 (220a), propeller 2-2 (220b), propeller 2-3 (220c), and propeller 2-4 (220d) may be connected respectively to the motor shafts of motor 2-1 (230a), motor 2-2 (230b), motor 2-3 (230c), and motor 2-4 (230d).

In various embodiments, the second electrical contacts 240 can be electrically connected to the first electrical contacts 140 of the first assembly 100 shown in FIG. 2B. The second electrical contacts 240 may receive control signals from the control means such as a processor and navigation system of the first assembly 100.

In various embodiments, the second electrical contacts 240 may be arranged on the upper section of the frame 210. The second electrical contacts 240 may be a male connector. The second electrical contacts 240 may include at least one of electrical contact 2-1 (240a), electrical contact 2-2 (240b), electrical contact 2-3 (240c), or electrical contact 2-4 (240d).

In various embodiments, the second assembly 200 of the unmanned aerial vehicle kit of the disclosure may include various components in addition to those components described above.

In various embodiments, the second assembly 200 may have various shapes without being limited to the shape shown in FIG. 3A or 3B. In the second assembly 200, the number of second rods 212, the number of second propellers 220, and the number of second motors 230 may be varied according to the shape of the frame 210. The number of second rods 212 arranged in the second assembly 100 may be 1, n according to the shape of the frame 210. The number of second propellers 220 arranged in the second assembly 200 may be 1, 2, . . . n according to the shape of the frame 210. The number of second motors 230 arranged in the second assembly 100 may be 1, 2, . . . , n according to the shape of the frame 210.

In various embodiments, when the first assembly 100 and the second assembly 200 are interconnected, electrical contact 2-1 (240a), electrical contact 2-2 (240b), electrical contact 2-3 (240c), and electrical contact 2-4 (240d) of the second assembly 200 can be in contact with electrical contact 1-1 (140a), electrical contact 1-2 (140b), electrical contact 1-3 (140c), and electrical contact 1-4 (140d) of the first assembly 100, respectively.

In various embodiments, the second electrical contacts 240 and the first electrical contacts 140 may be of a contact type, a connector type such as USB, and a non-contact type of short range communication (e.g., NFC, Bluetooth, or WiFi).

In various embodiments, when the first electrical contacts 140 of the first assembly 100 and the second electrical contacts 240 of the second assembly 200 are connected, the second assembly 200 may operate the second motors 230 and the second propellers 220 according to control signals output from the control means such as a processor and navigation system of the first assembly 100.

In various embodiments, the second electrical contacts 240 may receive control signals from the control means such as the processor 111 or the navigation system 113 of the first assembly 100 via the first electrical contacts 140. The second electrical contacts 240 may include an identity pin for identifying the type of the second assembly 200. The processor 111 or the navigation system 113 of the first assembly 100 may identify the type of the second assembly 200 by using contact methods based on an ID pin and the like, or contactless methods such as Bluetooth low energy (BLE) tags, magnetic sensing, and radio frequency identification (RFID). The type of the second assembly 200 can be determined through various other methods.

With reference to FIG. 3B, in various embodiments, the frame 210 of the second assembly 200 may include a mounting element 211, a cover element 213, and a fixing element 215.

In various embodiments, the mounting element 211 may be formed on the upper surface of the frame 210. The mounting element 211 may include a structure connectable with the first assembly 100. The mounting element 211 may include a mounting groove structure that can mount the back surface shape of the first assembly 100 in whole or in part. The mounting element 211 may include a structure capable of mounting and fixing at least a part of the housing 110, rod 1-1 (112a), rod 1-2 (112b), rod 1-3 (112c), and rod 1-4 (112d) of the first assembly 100.

In various embodiments, the cover element 213 may be a protective cover that covers and protects at least a part of the first assembly 100 when the first assembly 100 is connected with the mounting element 211 of the frame 210. For example, the housing 110 may include the first rods 112. The cover element 213 may cover and fix at least a part of the housing 110 of the first assembly 100 to thereby prevent the first assembly 100 from being detached from the second assembly 200 while the unmanned aerial vehicle kit is flying or running. When one end of the cover element 213 is connected to one side of the frame 210, the other end can be opened or closed up and down. The cover element 213 may be formed to be slidable forward and backward while one end thereof is connected to one side of the frame 210.

In various embodiments, at least one fixing element 215 may be provided on the upper surface of the frame 210. The fixing element 215 may be provided in an area of the frame 210 other than the area where the mounting element 211 is formed. The fixing element 215 can fix at least a part of the cover element 213, preventing the cover element 213 from being moved. The fixing element 215 may detachably connect and fix the cover element 213 to the frame 210. For example, when the first assembly 100 is connected to the mounting element 211 of the frame 210 and the cover element 213 covers the first assembly 100, the fixing element 215 can fix the cover element 213 so that it is not open from the frame 210.

Part (A) of FIG. 4 is a view showing the connection state between the first assembly 100 and the second assembly 200 of the unmanned aerial vehicle kit 10 according to various embodiments of the disclosure. Part (B) of FIG. 4 is an enlarged view of the section taken along the line A-A′ in part (A) of FIG. 4. Part (B) of FIG. 4 is an enlarged view showing the connection state between the cover element 213 and the fixing element 215.

With reference to parts (A) and (B) of FIG. 4, in various embodiments, the cover element 213 may include a locking groove 214 and the fixing element 215 may include a locking protrusion 216.

In various embodiments, at least one locking groove 214 may be formed on at least a section of two sides of the cover member 213. At least one locking protrusion 216 may be formed at a specific position inside the fixing element 215. The locking protrusion 216 may include a hook. The cover element 213 and the fixing element 215 can be connected or disconnected through the locking groove 214 of the cover element 213 and the locking protrusion 216 of the fixing element 215. For example, when the cover element 213 is slid forward by a pressure while the first assembly 100 is covered with the cover element 213, the locking groove 214 may be hooked and connected to and supported by the locking protrusion 216 of the fixing element 215. When the cover element 213 is slid backward by a pressure while the first assembly 100 is covered with the cover element 213, the locking groove 214 may be detached from the locking protrusion 216 of the fixing element 215.

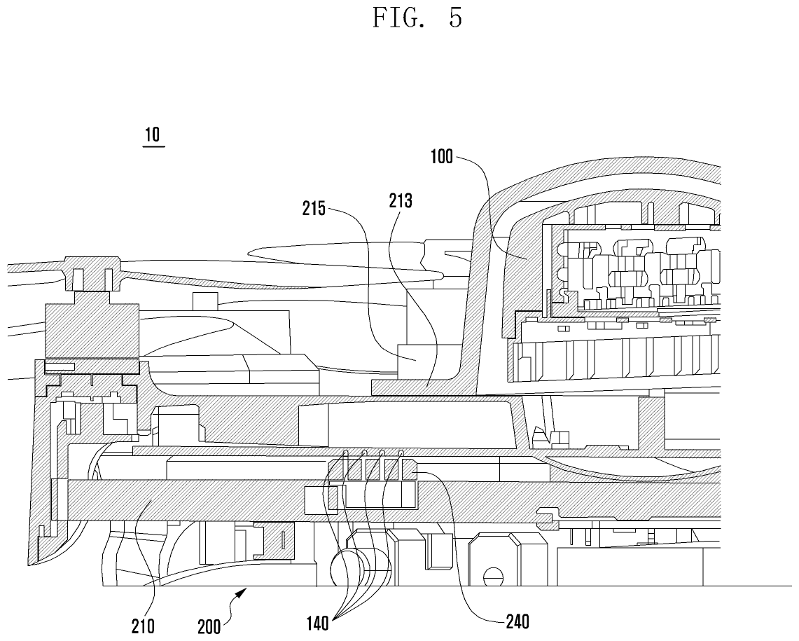

FIG. 5 is a cross-sectional view illustrating a portion of the connection state between the first assembly 100 and the second assembly 200 of the unmanned aerial vehicle kit 10 according to various embodiments of the disclosure.

With reference to FIG. 5, in various embodiments, the first assembly 100 of the unmanned aerial vehicle kit 10 may be mounted on the frame 210 of the second assembly 200. The first assembly 100 may be covered and protected by the cover element 213 whose one end is connected to one side of the frame 210. The cover element 213 may be connected to the fixing element 215 on the frame 210. This enables a stable connection between the first electrical contact 140 of the first assembly 100 and the second electrical contact 240 of the second assembly 200.

In various embodiments, the first electrical contact 140 may be a female connector and the second electrical contact 240 may be a male connector. In various embodiments, although not shown, the first electrical contact 140 may be a male connector and the second electrical contact 240 may be a female connector. The first electrical contact 140 and the second electrical contact 240 may be of a contact type, a connector type such as USB, and a non-contact type of short range communication (e.g., NFC, Bluetooth, or WiFi).

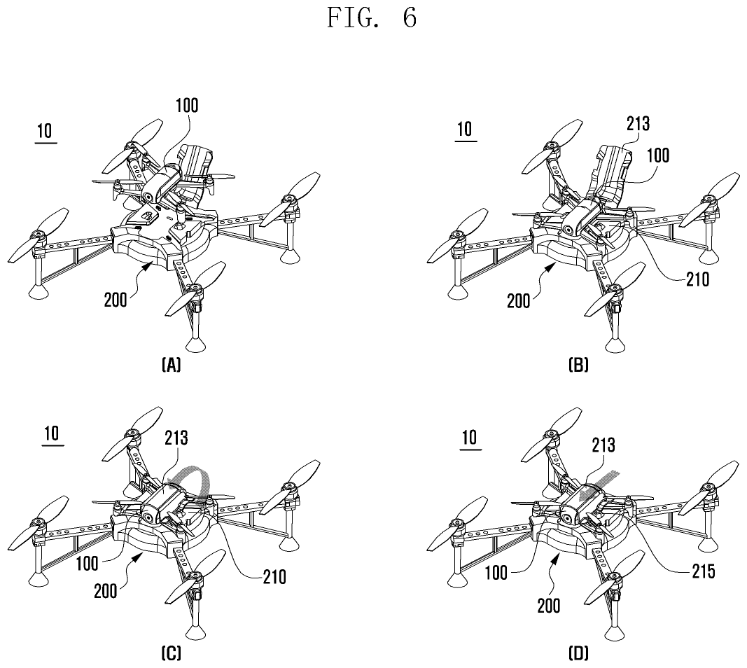

FIG. 6 illustrates a connection sequence of the unmanned aerial vehicle kit 10 according to various embodiments of the disclosure.

In various embodiments, the first assembly 100 and the second assembly 200 can be prepared as shown in part (A) of FIG. 6. The first assembly 100 may be prepared on top of the second assembly 200.

In various embodiments, the first assembly 100 may be mounted on the mounting element (e.g., mounting element 211 of FIG. 3B) formed on the frame 210 of the second assembly 200 as shown in part (B) of FIG. 6. Here, the cover element 213 whose one end is connected to one side of the frame 210 may be opened to mount the first assembly 100.

In various embodiments, after being mounted on the frame 210 of the second assembly 200, the first assembly 100 may be covered by the cover element 213 as shown in part (C) of FIG. 6. Here, the cover element 213 may be open upward and then closed while being rotated downward.

In various embodiments, if an external pressure is applied when the cover element 213 covers the first assembly 100, the cover element 213 may be slid forward and then hooked and supported by the fixing element 215 as shown in part (D) of FIG. 6. Thereby, the first assembly 100 may be detachably connected to the top of the second assembly 200.

In FIG. 6, the first assembly 100 is described as being detachably connected to or separated from the second assembly 200 through the cover element 213 and the fixing element 215 of the second assembly 200. However, this is only one of various embodiments, and various other methods can be used as long as the first assembly 100 and the second assembly 200 can be detachably connected.

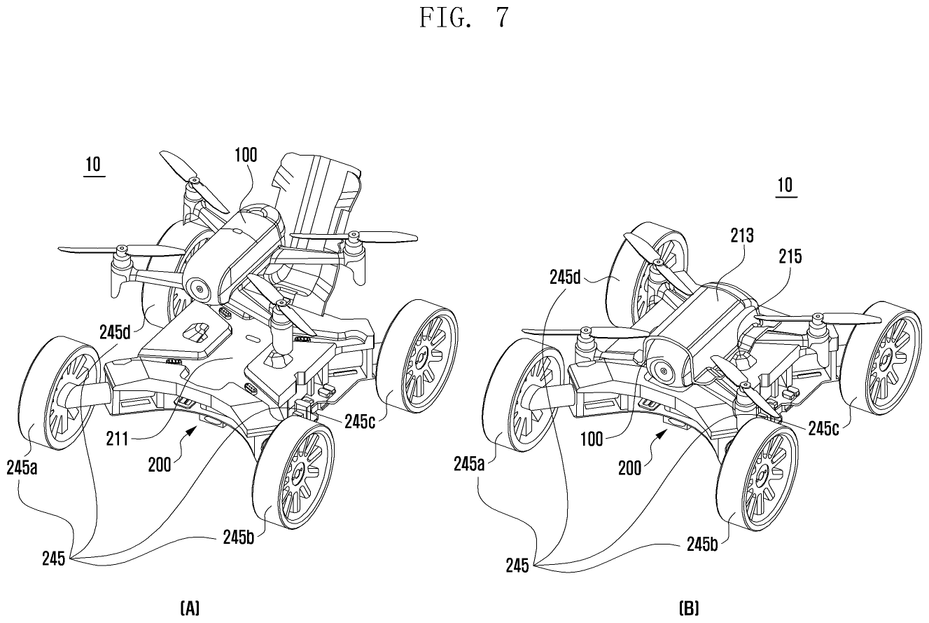

FIG. 7 shows another unmanned aerial vehicle kit 10 according to various embodiments of the disclosure.

In various embodiments, the first assembly 100 and the second assembly 200 can be prepared as shown in part (A) of FIG. 7. The first assembly 100 may be prepared on top of the second assembly 200.

In various embodiments, the second assembly 200 may include at least one wheel 245 for on-land travel instead of the second propellers 220 shown in FIG. 3B. The wheels 245 of the second assembly 200 may include a first wheel 245a, a second wheel 245b, a third wheel 245c and a fourth wheel 245d corresponding respectively to propeller 2-1 (220a), propeller 2-2 (220b), propeller 2-3 (220c), and propeller 2-4 (220d). The wheels 245 of the second assembly 200 may include various other rotating elements.

In various embodiments, the first assembly 100 may be mounted on the mounting element (e.g., mounting element 211 in FIG. 3B) formed on the frame 210 of the second assembly 200 and then covered with the cover element 213 as shown in part (B) of FIG. 7. Here, the cover element 213 may be opened upward and then closed while being rotated downward. If an external pressure is applied when the cover element 213 covers the first assembly 100, the cover element 213 may be slid forward and then hooked and supported by the fixing element 215. Thereby, the first assembly 100 may be detachably connected to the top of the second assembly 200.

In various embodiments, the first assembly 100 may be capable of flying or traveling alone. The second assembly 200 may be electrically connected to the first assembly 100, and the second assembly 200 may be controlled by the first assembly 100. The first assembly 100 may transmit a control signal to the second assembly 200 in accordance with the type of the second assembly 200. In various embodiments, the control signal transmitted by the first assembly 100 to the second assembly 200 can control at least one of the on-and-off state, rotation direction, or rotation speed of the second motors 230.

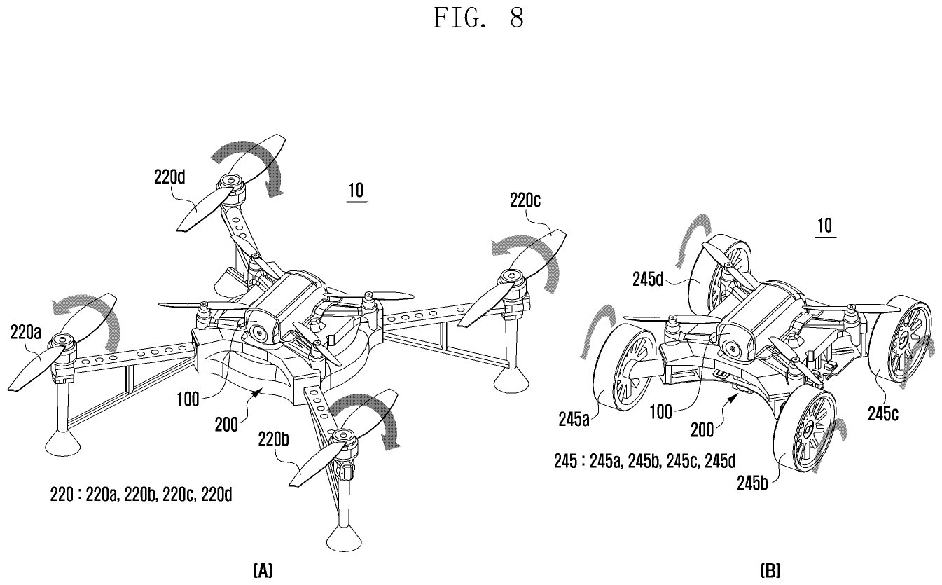

FIG. 8 illustrates different unmanned aerial vehicle kits 10 according to various embodiments of the disclosure. The second assembly 200 of the unmanned aerial vehicle kit 10 shown in part (A) of FIG. 8 is an aerial vehicle.

The second assembly 200 of the unmanned aerial vehicle kit 10 shown in part (B) of FIG. 8 is a traveling vehicle.

In various embodiments, when the second assembly 200 of the unmanned aerial vehicle kit 10 is an aerial vehicle as shown in part (A) of FIG. 8, among the second propellers 220, propeller 2-1 (220a) paired with propeller 2-3 (220c) and propeller 2-2 (220b) paired with propeller 2-4 (220d) can be rotated in opposite directions. For example, propeller 2-1 (220a) and propeller 2-3 (220c) can be rotated counterclockwise, and propeller 2-2 (220b) and propeller 2-4 (220d) can be rotated clockwise. In the second assembly 200, the number of second rods 212, the number of second propellers 220, and the number of second motors 230 may be varied according to the shape of the frame 210. The number of second rods 212 arranged in the second assembly 100 may be 1, 2, . . . , n according to the shape of the frame 210. The number of second propellers 220 arranged in the second assembly 200 may be 1, 2, . . . , n according to the shape of the frame 210. The number of second motors 230 arranged in the second assembly 100 may be 1, 2, . . . , n according to the shape of the frame 210.

In various embodiments, when the second assembly 200 of the unmanned aerial vehicle kit 10 is a traveling vehicle as shown in part (B) of FIG. 8, all the wheels 245 including the first wheel 245a, the second wheel 245b, the third wheel 245c and the fourth wheel 245d may be rotated in the same direction according to forward or backward movement.

In various embodiments, the second assembly 200 can be controlled by the first assembly 100. The first assembly 100 may transmit a control signal to the second assembly 200 depending on the type of the second assembly 200 being an aerial vehicle or a traveling vehicle.

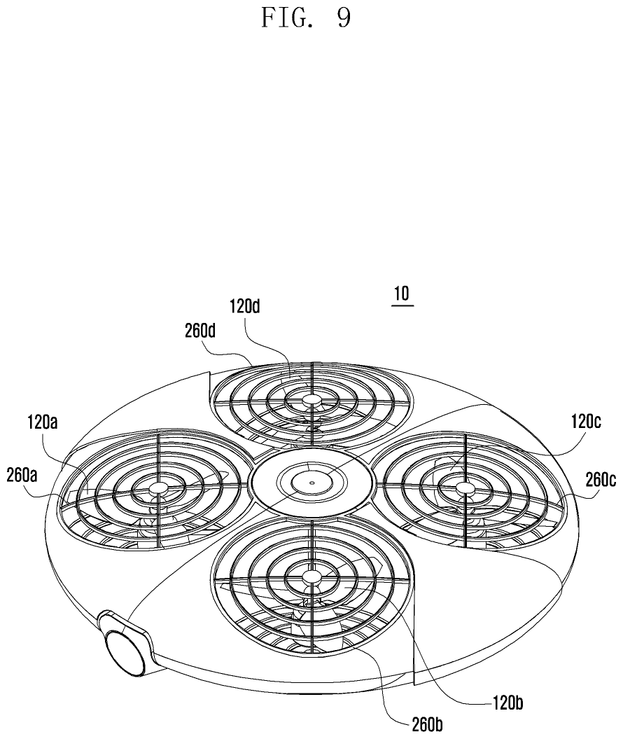

FIG. 9 illustrates another example of the unmanned aerial vehicle kit according to various embodiments of the disclosure.

With reference to FIG. 9, in various embodiments, the unmanned aerial vehicle kit 10 may include a protective cover 260 for accommodating and protecting the first assembly (e.g., first assembly 100 in FIG. 2A).

In various embodiments, the protective cover 260 may have a cylindrical or oval shape. One or more air holes (e.g., first air hole 260a, second air hole 260b, third air hole 260c, and fourth air hole 260d) may be formed on the upper and lower portions of the protective cover 260 so that air can flow smoothly to the first propellers (e.g., first propellers 120 in FIG. 2A) of the first assembly. The first air hole 260a, the second air hole 260b, the third air hole 260c, and the fourth air hole 260d can be arranged at positions corresponding respectively to propeller 1-1 (120a), propeller 1-2 (120b), propeller 1-3 (120c) and propeller 1-4 (120d) of the first assembly. The first air hole 260a, the second air hole 260b, the third air hole 260c, and the fourth air hole 260d may be in the form of a lattice or a net.

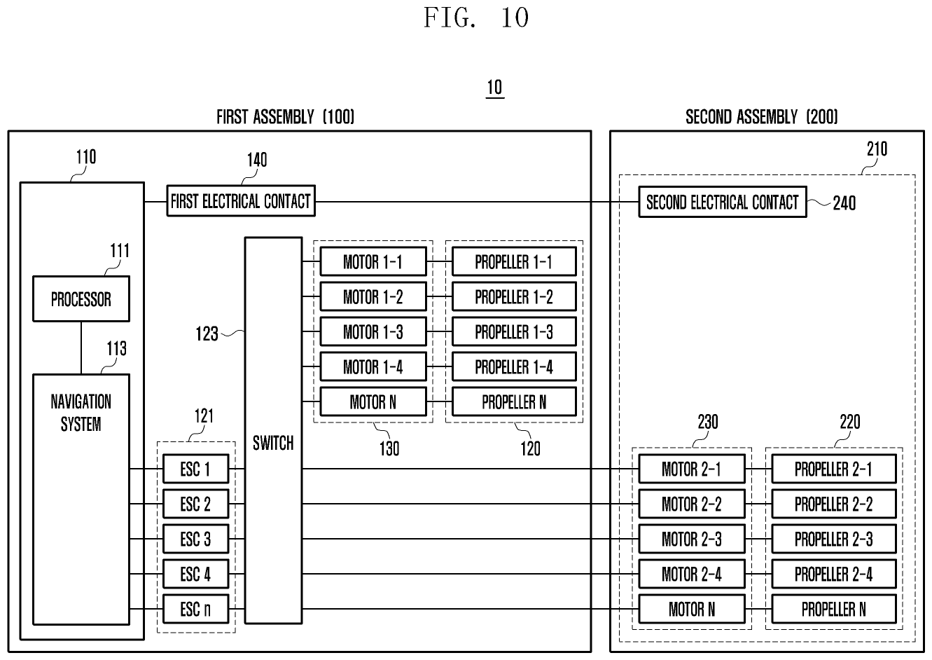

FIG. 10 is a block diagram of the unmanned aerial vehicle kit 10 according to various embodiments of the disclosure.

With reference to FIG. 10, in various embodiments, the unmanned aerial vehicle kit 10 may include a first assembly 100 and a second assembly 200. In one embodiment, the unmanned aerial vehicle kit 10 shown in FIG. 10 may be implemented as an unmanned aerial system.

In various embodiments, the first assembly 100 may include a housing 110, first propellers 120, first motors 130, and first electrical contacts 140.

In various embodiments, the housing 110 may constitute the body of the first assembly 100. The housing 110 may include control means such as a processor 111 and a navigation system 113. The processor 111 and the navigation system 113 may perform control operations necessary for driving and flying the first assembly 100.

In various embodiments, the processor 111 may control each function and operation of the first assembly 100. For example, the processor 111 may include a central processing unit (CPU), an application processor, a communication processor, and the like. The navigation system 113 can find a flight path or traveling path of the first assembly 100.

In various embodiments, the first propellers 120 may be connected to or mounted on the housing 110. The first propellers 120 may be arranged to fly the first assembly 100. The first propeller 120 may be disposed at the end of the first rod 112 connected to the housing 110. The first propellers 120 (e.g., first propellers 120 shown in FIG. 2A) may include at least one of propeller 1-1 (120a), propeller 1-2 (120b), propeller 1-3 (120c), or propeller 1-4 (120d), which is configured to rotate about a first axis extended in a first direction. In one embodiment, the first propellers 120 may include a rotating element.

In various embodiments, the first propellers 120 may be not limited to propeller 1-1 (120a) to propeller 1-4 (120d). The number of first propellers 120 may be more than one according to the shape of the housing 110 (e.g., propeller 1-1, . . . , propeller n).

In various embodiments, the first motors 130 may be configured to be controlled by at least one of the processor 111 or the navigation system 113. The first motors 130 may be configured to rotate the first propellers 120 connected to the motor shafts under the control of the processor 111 or the navigation system 113 so as to fly the first assembly 100. The first motors 130 may include at least one of motor 1-1 (130a), motor 1-2 (130b), motor 1-3 (130c), or motor 1-4 (130d) (e.g., first motors 130 shown in FIG. 2A). Propeller 1-1 (120a), propeller 1-2 (120b), propeller 1-3 (120c), and propeller 1-4 (120d) may be connected respectively to the motor shafts of motor 1-1 (130a), motor 1-2 (130b), motor 1-3 (130c), and motor 1-4 (130d).

In various embodiments, the first motors 130 may be not limited to motor 1-1 (130a) to motor 1-4 (130d). The number of first motors 130 may be more than one according to the shape of the housing 110 (e.g., motor 1-1, . . . , motor n).

In various embodiments, electronic speed controls (ESCs) 121 and switches 123 may be included between the housing 110 and the first motors 130. The ESCs 121 may control the speed of the first motors 130 or the second motors 230 according to the control of the processor 111 or the navigation system 113.

In various embodiments, the number of ESCs 121 (e.g., ESC 1, . . . , ESC n) may correspond to the number of first motors 130 (e.g., motor 1-1, , motor n) or the number of second motors 130 (e.g., motor 2-1, . . . , motor n).

In various embodiments, the switches 123 may selectively drive the first motors 130 or the second motors 230 according to the control of the processor 111 or the navigation system 113.

In various embodiments, the first electrical contacts 140 may be electrically connected to the processor 111 or the navigation system 113. The first electrical contacts 140 may be electrically connected to the second electrical contacts 240 of the second assembly 200. The first electrical contacts 140 may transmit control signals from the control means such as the processor 111 or the navigation system 113 to the second electrical contacts 240.

In various embodiments, the first electrical contacts 140 may include an identity pin for identifying the type of the second assembly 200. The processor 111 or the navigation system 113 of the first assembly 100 may identify the type of the second assembly 200 by using contact methods based on an ID pin and the like, or contactless methods such as Bluetooth low energy (BLE) tags, magnetic sensing, and radio frequency identification (RFID). The type of the second assembly 200 can be determined through various other methods.

In various embodiments, the second assembly 200 may include a frame 210, second propellers 220, second motors 230, and second electrical contacts 240.

In various embodiments, the frame 210 may be detachably connected to the first assembly 100. The frame 210 of the second assembly 200 may be integrally connected to the first assembly 100 to form the unmanned aerial vehicle kit 10.

In various embodiments, the second propellers 220 may be connected to or mounted on the frame 210. The second propellers 220 may be configured to fly and run the second assembly 200 under the control of the processor 111 or the navigation system 113 of the first assembly 100. The second propeller 220 may be disposed at the end of the second rod (e.g., second rod 212 in FIG. 3A) connected to the frame 210. The second propellers 220 may include at least one of propeller 2-1 (220a), propeller 2-2 (220b), propeller 2-3 (220c), or propeller 2-4 (220d) each configured to rotate about a second axis different from the first axis of the first propeller 120. In one embodiment, the second axis may be parallel to the first axis. In another embodiment, the second axis may be substantially perpendicular to the first axis. In one embodiment, the second propeller 220 may include at least one of a rotating element or a wheel.

In various embodiments, the second propellers 220 may be not limited to propeller 2-1 (220a) to propeller 2-4 (220d). The number of second propellers 220 may be more than one according to the shape of the frame 210 (e.g., propeller 2-1, . . . , propeller n).

In various embodiments, the second motors 230 may be configured to be controlled by at least one of the processor 111 or the navigation system 113 of the first assembly 100. The second motors 230 may be configured to rotate the second propellers 220 connected to the motor shafts so as to fly the second assembly 200. The second motors 230 may include at least one of motor 2-1 (230a), motor 2-2 (230b), motor 2-3 (230c), or motor 2-4 (230d). Propeller 2-1 (220a), propeller 2-2 (220b), propeller 2-3 (220c), and propeller 2-4 (220d) may be connected respectively to the motor shafts of motor 2-1 (230a), motor 2-2 (230b), motor 2-3 (230c), and motor 2-4 (230d). The rotational speed of the second motors 230 may be controlled according to control signals from the electronic speed controls (ESCs) 121 of the first assembly 100. The switches 123 provided in the first assembly 100 may selectively drive the second motors 230 according to the control of the processor 111 or the navigation system 113.

In various embodiments, the second motors 230 may be not limited to motor 2-1 (230a) to motor 2-4 (230d). The number of second motors 230 may be more than one according to the shape of the frame 210 (e.g., motor 2-1, . . . , motor n).

In various embodiments, the second electrical contacts 240 may be electrically connected to the first electrical contacts 140 of the first assembly 100 when the frame 210 of the second assembly 200 and the first assembly 100 are interconnected. The second electrical contacts 240 may receive a control signal from the control means such as the processor 111 or the navigation system 113 of the first assembly 100 through the first electrical contacts 140. The second electrical contacts 240 may include an ID pin for identifying the type of the second assembly 200. The processor 111 or the navigation system 113 of the first assembly 100 may identify the type of the second assembly 200 by using contact methods based on an ID pin and the like, or contactless methods such as Bluetooth low energy (BLE) tags, magnetic sensing, and radio frequency identification (RFID). The type of the second assembly 200 can be determined through various other methods.

In various embodiments, when the first electrical contacts 140 of the first assembly 100 and the second electrical contacts 240 of the second assembly 200 are connected, the second assembly 200 may operate the second motors 230 and the second propellers 220 according to a control signal output from the control means such as the processor 111 or the navigation system 113 of the first assembly 100.

In various embodiments, when the first electrical contacts 140 of the first assembly 100 and the second electrical contacts 240 of the second assembly 200 are connected, the processor 111 or the navigation system 113 of the first assembly 100 may determine the type of the second assembly 200 and transmit a control signal corresponding to the type of the second assembly 200.

In various embodiments, at least one of the processor 111 or the navigation system 113 may selectively drive the first motors 130 of the first assembly 100 or the second motors 230 of the second assembly 200 by controlling the switches 123 depending on whether the second assembly 200 is connected to the first assembly 100.

In various embodiments, at least one of the processor 111 or the navigation system 113 may be configured to detect whether the second assembly 200 is connected to the first assembly 100 based on whether the first electrical contacts 140 and the second electrical contacts 240 are interconnected.

In various embodiments, at least one of the processor 111 or the navigation system 113 may be configured to automatically change the rotational direction of the first motors 130 or the second motors 230 depending on whether the second assembly 200 is connected to the first assembly 100.

In various embodiments, the first motors 130 may be provided only in the first assembly 100 of the unmanned aerial vehicle kit 10 and the second motors 230 may be not provided in the second assembly 100. In this case, only the second assembly 100 is provided with the second propellers 220 and the first assembly 100 may be not provided with the first propellers 120 at least temporarily. In one embodiment, at least one of the processor 111 or the navigation system 113 may determine the type of the second assembly 200 when the second assembly 200 is connected to the first assembly 100. At least one of the processor 111 or the navigation system 113 of the first assembly 100 may transmit a control signal corresponding to the type of the second assembly 200 to the second assembly 200 through the first electrical contacts 140 and the second electrical contacts 240. Hence, the first motors 130 of the first assembly 100 may control the rotational direction and speed of the second propellers 220 of the second assembly 200.

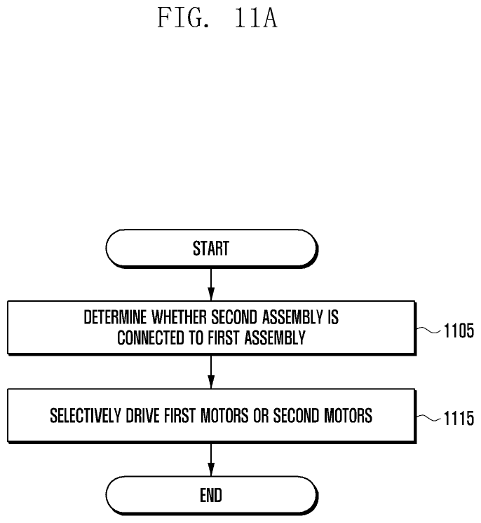

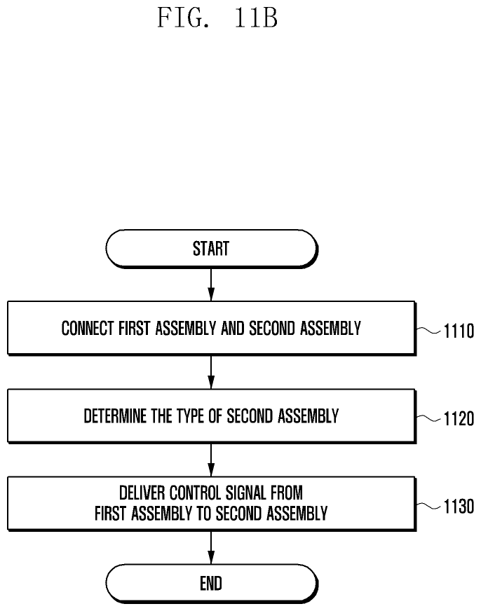

FIG. 11A is a flowchart of a method for selectively driving the first motors of the first assembly or the second motors of the second assembly according to various embodiments of the disclosure.

At operation 1105, at least one of the processor 111 or the navigation system 113 of the first assembly 100 may determine whether the second assembly 200 is connected.

At operation 1115, at least one of the processor 111 or the navigation system 113 of the first assembly 100 may selectively drive the first motors 130 of the first assembly 100 or the second motors 230 of the second assembly 200 depending on whether the second assembly 200 is connected.

In one embodiment, if the second assembly 100 is not connected, at least one of the processor 111 or the navigation system 113 of the first assembly 100 may drive the first motors 130. If the second assembly 100 is connected, at least one of the processor 111 or the navigation system 113 of the first assembly 100 may drive the second motors 230.

FIG. 11B is a flowchart of a method for transmitting a control signal by the unmanned aerial vehicle kit 10 according to various embodiments of the disclosure. FIG. 11 may be related to a method for delivering a control signal corresponding to the type of the second assembly 200.

At operation 1110, the user may connect the second assembly 200 suitable for the usage purpose to the first assembly 100.

At operation 1120, at least one of the processor 111 or the navigation system 113 of the first assembly 100 may determine the type of the second assembly 200.

In various embodiments, the type of the second assembly 200 may be an aerial vehicle capable of flying in the air through propellers, a traveling vehicle capable of running on land through wheels, or an underwater vehicle capable of travelling in water.

In various embodiments, the type of the second assembly 200 may be determined when the first electrical contacts 140 of the first assembly 100 and the second electrical contacts 240 of the second assembly 200 are connected. The second electrical contacts 240 may include an identity pin for identifying the type of the second assembly 200. The processor 111 or the navigation system 113 of the first assembly 100 may identify the type of the second assembly 200 by using contact methods based on an ID pin and the like, or contactless methods such as Bluetooth low energy (BLE) tags, magnetic sensing, and radio frequency identification (RFID). The type of the second assembly 200 can be determined through various other methods.

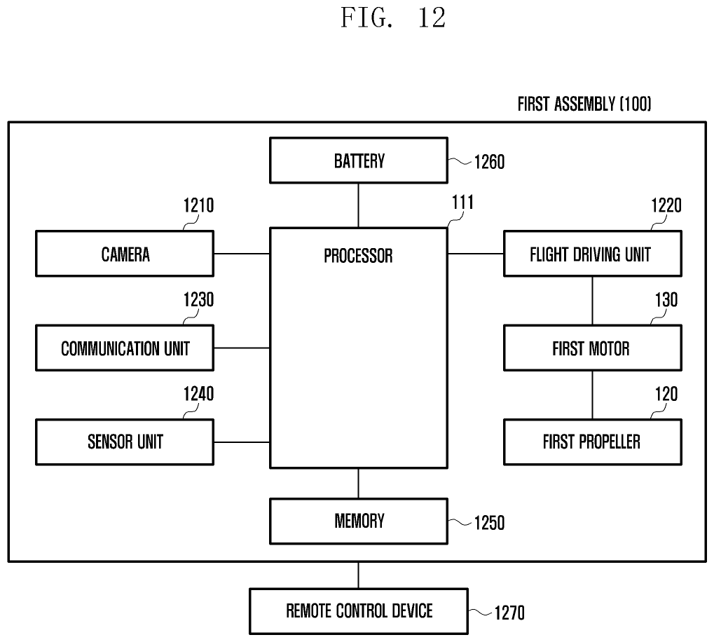

In various embodiments, the control instructions corresponding to the type of the second assembly 200 may be stored in a memory (e.g., memory 1260 of FIG. 12). At least one of the processor 111 or the navigation system 113 of the first assembly 100 may control the execution of the instructions stored in the memory according to the type of the second assembly 200.

In various embodiments, if the second assembly 200 is an aerial vehicle as shown in part (A) of FIG. 8, at least one of the processor 111 or the navigation system 113 of the first assembly 100 may control the second propellers 220 for first mode (e.g., flight mode) so that propeller 2-1 (220a) paired with propeller 2-3 (220c) and propeller 2-2 (220b) paired with propeller 2-4 (220d) can be rotated in opposite directions. If the second assembly 200 is a traveling vehicle as shown in part (B) of FIG. 8, at least one of the processor 111 or the navigation system 113 of the first assembly 100 may control the wheels 245 for second mode (e.g., traveling mode) so that the first wheel 245a, the second wheel 245b, the third wheel 245c and the fourth wheel 245d may be rotated in the same direction according to forward or backward movement. In one embodiment, the user may manually change the mode between the first mode and the second mode through a switch (not shown) depending on the type of the second assembly 200. In one embodiment, if the second assembly 200 is an underwater vehicle, at least one of the processor 111 or the navigation system 113 may control the rotation of one or more screws (not shown) for third mode (e.g., underwater mode).

At operation 1130, at least one of the processor 111 or the navigation system 113 of the first assembly 100 may transmit a control signal corresponding to the type of the second assembly 200 to the second assembly 200 through the first electrical contacts 140 and the second electrical contacts 240.

In various embodiments, the second motors 230 of the second assembly 200 may be driven according to the control signal transmitted from the first assembly 100.

FIG. 12 is a block diagram illustrating additional components of the first assembly 100 according to various embodiments of the disclosure. The first assembly 100 according to various embodiments of the disclosure may further include the components shown in FIG. 12 in addition to those components of the first assembly 100 shown in FIG. 10.

With reference to FIG. 12, in various embodiments, the first assembly 100 may further include a camera 1210, a flight driving unit 1220, a communication unit 1230, a sensor unit 1240, a memory 1250, and a battery 1260. The first assembly 100 can send and receive control signals to and from a remote control device 1270.

In various embodiments, at least one camera 1210 may be provided to capture a still image and a moving image. The at least one camera 1210 may include a gimbal camera. The camera 1210 may include one or more image sensors (e.g., front sensor and rear sensor), a lens, an image signal processor (ISP), and a flash (e.g., LED or xenon lamp).

In various embodiments, the flight driving unit 1220 may generate power to lift the first assembly 100 in the air. The flight driving unit 1220 may be configured to include the first motors 130 and the first propellers 120. The flight driving unit 1220 may generate a drive signal for the first motors 130 to control the flight of the first assembly 100. The first propellers 120 may rotate according to the drive signals of the first motors 130 of the flight driving unit 1220.

In various embodiments, the communication unit 1230 can perform communication with the processor 111 controlling the first assembly 100 and the remote control device 1270. The communication unit 1230 may receive a control signal from the remote control device 1270 for controlling the first assembly 100. The communication unit 1230 may transmit information on the flight and traveling state of the first assembly 100 to the remote control device 1270. The processor 111 can control the movement of the first assembly 100 by controlling the flight driving unit 1220 according to the control signal received through the communication unit 1230 from the remote control device 1270.

In various embodiments, the sensor unit 1240 may calculate the attitude and position of the first assembly 100. The sensor unit 1240 may measure a specific physical quantity or sense the operating state of the first assembly 100, and convert the measured or sensed information into an electrical signal. The sensor unit 1240 may include a gyro sensor, a barometer, a terrestrial magnetism sensor (e.g., compass sensor), an acceleration sensor, a proximity sensor, and an optical sensor.

In various embodiments, the gyro sensor may measure the angular velocity of the first assembly 100. The barometer may measure atmospheric pressure changes and/or atmospheric pressure. The terrestrial magnetism sensor may measure the Earth's magnetic field. The acceleration sensor may measure the acceleration of the first assembly 100. The proximity sensor can measure the proximity and distance of an object. In one embodiment, the proximity sensor may include an ultrasonic sensor that outputs an ultrasonic wave and detects a signal reflected from an object to measure the distance. The optical sensor (OPS, optical flow) can calculate the position by recognizing the terrain or pattern of the earth.

In various embodiments, the sensor unit 1240 may further include a gesture sensor, a color sensor (e.g., RGB (red, green, blue) sensor), a temperature/humidity sensor, and an illuminance sensor. The sensor unit 1240 may further include a control circuit for controlling the above-described sensors.

In various embodiments, the memory 1250 may store control instructions corresponding to the type of the second assembly 200. The memory 1250 may store a program for processing and controlling operations of the processor 111 of the first assembly 100, an operating system (OS), various applications, and input/output data. The memory 1250 may store a program that controls the overall operation of the first assembly 100. The memory 1250 may store various configuration information required for the functional processing of the first assembly 100.

In various embodiments, the battery 1260 may supply power to the first assembly 100. The first assembly 100 can generate and output power required for driving the first assembly 100 using the electric power charged in the battery 1260. The battery 1260 may supply driving power to the first motors 130 configured to rotate the first propellers 120 of the first assembly 100. The battery 1260 may be at least one battery designed to be detachable from the first assembly 100.

In various embodiments, as the first assembly 100 communicates with the remote control device 1270, a battery for driving the first assembly 100 and a battery for wireless communication of the communication unit 1230 may be separately provided. The battery 1260 may include, for example, a nickel-cadmium (Ni-Cd), nickel-hydrogen (Ni-MH), lithium-ion (Li-Ion), or lithium-polymer (Li-Poly) battery. The battery 1260 may include a fuel cell, a chemical cell, and a solar cell. The battery 1260 may include a power management integrated circuit (PMIC), a charger integrated circuit (IC), and a battery or fuel gauge.

In various embodiments, the battery 1260 may supply power to the processor 111. The battery 1260 can receive a command from the processor 111 and manage power supply in response to the received command. For example, in response to a command received from the processor 111, the battery 1260 may supply power to the camera 1210, the flight driving unit 1220, the communication unit 1230, the sensor unit 1240, and the memory 1250.

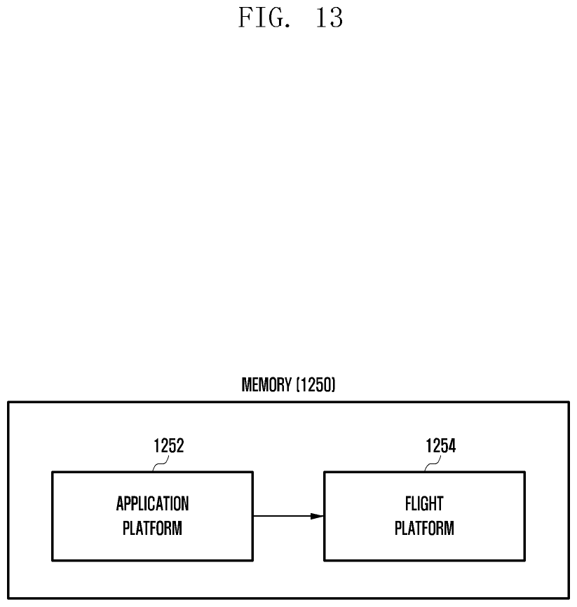

FIG. 13 shows program modules stored in the memory 1250 of the first assembly 100 according to various embodiments of the disclosure.

With reference to FIG. 13, in various embodiments, the memory 1250 of the first assembly 100 may include an application platform 1252 and a flight platform 1254.

In various embodiments, the first assembly 100 may receive a control signal from a remote control device (e.g., remote control device 1270 in FIG. 12). The application platform 1252 may be configured to provide services related to driving the first assembly 100. The flight platform 1254 may be configured to control the flight of the first assembly 100 according to navigation algorithms.

In various embodiments, the application platform 1252 can perform image control, communication control, sensor control, charge control, and switching between user applications for the components of the first assembly 100 (e.g., camera 1210, flight driving unit 1220, communication unit 1230, sensor unit 1240, memory 1250, and battery 1260 shown in FIG. 12). The flight platform 1254 may be configured to execute the flight, attitude control, and navigation algorithms of the first assembly 100. The application platform 1252 can transmit a steering signal (e.g., control signal) to the flight platform 1254 while performing image control, communication control, sensor control, charge control, and switching between user applications.

In various embodiments, the processor (processor 111 in FIG. 12) can obtain an image of a target object photographed through the camera 1210. The processor 111 may analyze the obtained image and generate a command to steer the first assembly 100 to fly. For example, the processor 111 may produce information regarding the size and the moving state of the target object, the relative distance between the camera 1210 and the target object, and the altitude and azimuth. The processor 111 may use the produced information to generate a steering signal such as a follow-up flight of the first assembly 100. The flight platform 1254 can control the flight, attitude, and movement of the first assembly 100 based on the generated steering signal.

In various embodiments, the first assembly 100 can measure the position, the flight attitude, the angular velocity and the acceleration by use of the sensor unit 1240 and the GPS receiver. The information obtained through the sensor unit 1240 and the GPS receiver can be used as basic information to generate a steering signal for navigation or auto-piloting of the first assembly 100. The air pressure difference and the altitude information measured through the air pressure sensor and the ultrasonic sensor of the sensor unit 1240 during the flight of the first assembly 100 may be used as basic information to generate a steering signal for navigation or auto-piloting of the first assembly 100. In addition, the steering data signal received from the remote control device 1270 and the status information of the battery 1260 of the first assembly 100 may be used as basic information to generate a steering signal for navigation or auto-piloting of the first assembly 100.

In various embodiments, the first assembly 100 can fly using at least one first propeller (e.g., first propellers 120 in FIG. 12). The first motors (e.g., first motors 130 in FIG. 12) may change the rotational and propulsive forces of the first propeller 120. The first assembly 100 may have a different designation depending on the number of propellers. If the number of propellers is four, the first assembly 100 may be referred to as a quadcopter. If the number of propellers is six, the first assembly 100 may be referred to as a hexacopter. If the number of propellers is eight, the first assembly 100 may be referred to as an octocopter.

In various embodiments, the first assembly 100 may control the first propellers 120 based on a steering signal from the processor 111 or the remote control device 1270. The unmanned aerial vehicle kit 10 including the first assembly 100 can fly with two principles of lift and torque. For flight, the unmanned aerial vehicle kit 10 may rotate half of the second propellers 220 of the second assembly 200 in a clockwise direction and rotate the other half in a counter clockwise direction. The three-dimensional coordinates of the unmanned aerial vehicle kit 10 during flight can be determined by pitch (Y), roll (X) and yaw (Z).

In various embodiments, the unmanned aerial vehicle kit 10 including the first assembly 100 and the second assembly 200 can fly by tilting back and forth and left and right. When the unmanned aerial vehicle kit 10 is tilted, the direction of the air flow generated by the second propellers 220 may be changed. For example, when the unmanned aerial vehicle kit 10 is tilted forward, air can flow not only up and down but also slightly backward. This allows the unmanned aerial vehicle kit 10 to advance forward with the principle of action and reaction as the air layer is pushed back. Tilting the unmanned aerial vehicle kit (10) can be accomplished by reducing the speed of the front in the corresponding direction and increasing the speed of the rear. As this is common to all directions, the unmanned aerial vehicle kit 10 can be tilted to move only by adjusting the speed of the second motors 230.

In various embodiments, the unmanned aerial vehicle kit (10) may perform the attitude control with respect to pitch (Y), roll (X) and yaw (Z) and the flight control according to the movement route by using the application platform 1252 to generate a steering signal and the flight platform 1254 to control the second motors 230 of the second assembly 200 according to the steering signal.

Each of the components disclosed in the various embodiments of the disclosure may be composed of one or more components, and the names of the components may vary depending on the type. In various embodiments, the unmanned aerial vehicle kit 10 including the first assembly 100 and the second assembly 200 may be changed while retaining its original functionality by omitting an existing component, adding a new component, or combining existing components into a new component.

While the disclosure has been shown and described with reference to various embodiments thereof, it should be understood by those skilled in the art that many variations and modifications of the method and apparatus described herein will still fall within the spirit and scope of the disclosure as defined in the appended claims and their equivalents.

1. An unmanned aerial vehicle (UAV) kit comprising:
a first assembly including:
a housing including a processor and a navigation system;
at least one first propeller connected to or mounted on the housing and oriented to rotate about a first axis extending in a first direction;
at least one first motor configured to drive the at least one first propeller and be controlled by at least one of the processor or the navigation system; and
at least one first electrical contact electrically connected to the processor; and
a second assembly including:
a frame detachably connectable to the first assembly;
at least one second electrical contact electrically connectable to the at least one first electrical contact when the frame is connected to the first assembly;
at least one second propeller connected to or mounted on the frame and oriented to rotate about a second axis different from the first axis; and
at least one second motor configured to drive the at least one second propeller and be controlled by at least one of the processor or the navigation system,
wherein at least one of the processor or the navigation system is configured to selectively drive the first motor or the second motor depending on whether the second assembly is connected to the first assembly.

2. The kit of claim 1, wherein the second axis is parallel to the first axis.

3. The kit of claim 1, further comprising at least one electronic speed control (ESC) between the housing and the first motor to control the speed of the first motor or the second motor according to the control of the processor or the navigation system.

4. The kit of claim 1, further comprising a switch between the housing and the first motor to selectively drive the first motor or the second motor according to the control of the processor or the navigation system.

5. The kit of claim 1, wherein the frame includes:
a mounting element to mount at least a portion of the first assembly;
a cover element to cover at least a portion of the first assembly for protection when the first assembly is mounted on the mounting element; and
a fixing element to detachably connect and fix the cover element.

6. The kit of claim 5, wherein when one end of the cover element is connected to one side of the frame, the other end is opened or closed up and down and the cover element is formed to be slidable forward and backward.

7. The kit of claim 5, wherein at least one locking groove is formed on at least a section of two sides of the cover member, at least one locking protrusion is formed at a specific position inside the fixing element, and the cover element and the fixing element are connected or disconnected through the locking groove and the locking protrusion.

8. The kit of claim 1, wherein, when the second assembly is connected to the first assembly, at least one of the processor or the navigation system is configured to determine the type of the second assembly and cause the first assembly to transmit a control signal corresponding to the type of the second assembly through the first electrical contact to the second electrical contact of the second assembly.

9. The kit of claim 1, wherein when the second assembly is an aerial vehicle, at least one of the at least one second propeller is rotated in a first direction and at least another of the at least one second propeller is rotated in a second direction.

10. The kit of claim 9, wherein the type of the second assembly is at least an aerial vehicle, a traveling vehicle, or an underwater vehicle, and wherein at least one of the processor or the navigation system is configured to transmit a control signal corresponding to the type of the second assembly to the second assembly.

11. A system comprising:
a first assembly including:
a housing including a processor and a navigation system;
at least one first rotating element connected to or mounted on the housing and oriented to rotate about a first axis extending in a first direction;
at least one first motor configured to drive the at least one rotating element and be controlled by at least one of the processor or the navigation system; and
at least one first electrical contact electrically connected to the processor; and
a second assembly including:
a frame detachably connectable to the first assembly;
at least one second electrical contact electrically connectable to the at least one first electrical contact when the frame is connected to the first assembly;
at least one second rotating element connected to or mounted on the frame and oriented to rotate about a second axis different from the first axis; and
at least one second motor configured to drive the at least one second rotating element and be controlled by at least one of the processor or the navigation system,
wherein at least one of the processor or the navigation system is configured to selectively drive the first motor or the second motor depending on whether the second assembly is connected to the first assembly.

12. The system of claim 11, wherein the at least one first rotating element includes a propeller.

13. The system of claim 12, wherein the at least one second rotating element includes either a propeller or a wheel.

14. The system of claim 13, wherein the second axis is parallel to the first axis.

15. The system of claim 13, wherein the second axis is substantially perpendicular to the first axis.
